(19) United States
(12) Patent Application Publication
(10) Pub. No.: US 2026/0143017 A1
(43) Pub. Date: May 21, 2026

(54) CONFIGURING IMS CORE COMMUNICATIONS DURING DEDICATED BEARER SETUP

(71) Applicant: T-Mobile USA, Inc., Bellevue, WA (US)

(72) Inventor: Narayanan Govindan Kasi, Olathe, KS (US)

(21) Appl. No.: 18/951,257

(22) Filed: Nov. 18, 2024

(51) Int. Cl. H04L 65/1016; H04W 76/10; H04W 88/16

(52) U.S. Cl. CPC H04L 65/1016; H04W 76/10; H04W 88/16

(57) ABSTRACT

Techniques for setting up a communication session responsive to a dedicated bearer setup are described herein. A telecommunications network can direct an IMS core to establish communications with a specific PCF/PCRF. To direct the IMS core communication to communicate with a specific PCF/PCRF, a gateway generates bearer data that, among other functions, causes the IMS core to confirm communication with specific one or more PCFs/PCRFs or establish communications with specific one or more PCFs/PCRFs.

### BACKGROUND

Modern terrestrial telecommunication systems include heterogeneous mixtures of second, third, and fourth generation (2G, 3G, and 4G) cellular-wireless access technologies, which can be cross-compatible and can operate collectively to provide data communication services. Global Systems for Mobile (GSM) is an example of 2G telecommunications technologies; Universal Mobile Telecommunications System (UMTS) is an example of 3G telecommunications technologies; and Long Term Evolution (LTE), including LTE Advanced, and Evolved High-Speed Packet Access (HSPA+) are examples of 4G telecommunications technologies. Telecommunications systems may include fifth generation (5G) cellular-wireless access technologies to provide improved bandwidth and decreased response times to a multitude of devices that may be connected to a network.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 depicts an example network environment for directing IMS core communications, in accordance with some examples of the present disclosure.

FIG. 2 depicts an example system architecture for a fifth generation (5G) telecommunication network that may be used to implement an invite message analyzer, in accordance with some examples of the present disclosure.

FIG. 3 depicts a message flow during an example dedicated bearer setup implementing an invite message analyzer, in accordance with some examples of the present disclosure.

FIG. 4 is an illustrative process for establishing a dedicated bearer for a communication session, in accordance with some examples of the present disclosure.

FIG. 5 depicts a component level view of a server for use with the systems and methods described herein, in accordance with some examples of the present disclosure.

### DETAILED DESCRIPTION

Setting up a call in a telecommunications network can include implementing a default bearer to establish IP Multimedia Subsystem (“IP Multimedia Core Network,” “IMS,” or “IMS core”) control signaling and a dedicated bearer to route packets between the IMS core and a UE. However, the process of establishing the dedicated bearer may fail because of communication misconfiguration between an IMS core (or other function used to enable and manage communication sessions) and a Policy Control Function (PCF)/Policy and Charging Rules Function (PCRF) (PCF/PCRF or generically referred to herein as a “policy function”) of the telecommunications network. The use of a PCF or PCRF depends on which type of telecommunications network (5G, 4G, 3G, etc.) is being used. In the example of a 5G telecommunications network, when establishing a dedicated bearer, an IMS core selected by the network may be communication with a different PCF than a gateway used to coordinate the generation of the dedicated bearer. The gateway can represent one of a System Architecture Evolution Gateway (SAEGW), a Packet Data Network Gateway (PGW), a Session Management Function (SMF), a User Plane Function (UPF), a Serving Gateway (SGW), or the like depending on which telecommunications network (5G, 4G, 3G, etc.) is used by the UE. In those examples, whereby the IMS core is in communication with a different PCF/PCRF than the gateway, the dedicated bearer process may fail.

In further examples, it may be preferable to direct an IMS core to a specific one of policy functions (i.e., PCFs/PCRFs) capable of handling a call and may be based on the availability of the policy functions, Internet Protocol addresses of various components such as a user equipment or location, or the identification of a user equipment, and the like. For example, as part of establishing a dedicated bearer, the IMS core will establish or continue communications with a PCF/PCRF. However, it may be preferable to have the IMS core to establish or maintain communications with a specific PCF/PCRF for one or more call setups. This may be needed or preferable in various situations. For example, in a 5G telecommunications network, there may be a process whereby the PCFs/PCRFs are load balanced, meaning, the amount of traffic handled by the PCFs/PCRFs are adjusted so that each of the PCFs/PCRFs handle a percentage of the overall traffic. In another example, one or more of the PCFs/PCRFs may go offline or come online. Thus, it may be desirable to adjust the IMS core to communication with the PCFs/PCRFs that have come online or not try to communicate with PCFs/PCRFs that have gone offline. In other examples, the PCFs/PCRFs used may be prioritized whereby the IMS core is instructed to communicate with a PCF/PCRF that has a higher priority than other PCFs/PCRFs of lower priority. This may occur, for example, if a PCF/PCRF is physically closer to the initiating UE, in a location preferable to other PCFs/PCRFs, or have more capabilities than other PCFs/PCRFs.

To direct the IMS core communication with a specific PCF/PCRF, in some examples of the presently disclosed subject matter, a gateway generates bearer data that, among other functions, causes the IMS core to confirm communication with specific one or more PCFs/PCRFs or establish communications with specific one or more PCFs/PCRFs. The bearer data is used by the IMS core to determine which one of one or more PCFs/PCRFs the IMS core is to establish or confirm communications with. The bearer data can be based on various data received from different sources. For example, the bearer data directing communications may be based solely on the identification of the UE attempting to establish a voice call. In another example, the bearer data may be generated based on information received from a source such as a new radio function (NRF) attempting to commencing or continuing a load balancing process to load balance PCFs/PCRFs, a process of preventing an attempted use of inoperable or unavailable PCFs/PCRFs, or a process to commence the use of newly operable PCFs/PCRFs (e.g., policy functions that may have been inoperable prior to a query by the gateway and have been brought online to be used), and the like.

In some examples, the gateway is configured to read an incoming Session Initiation Protocol (SIP) INVITE message from a user equipment (UE), using an INVITE Message analyzer, to establish a voice communication (e.g., a Voice over New Radio (VoNR) voice call or a VoNR emergency call). The gateway reads the incoming SIP INVITE Message and determines which PCF/PCRF the UE will have a dedicated bearer established with. The IP address and the PCF/PCRF that the UE will use (bearer data) is passed onto the IMS core. The IMS core receives the bearer data and, if not done so already, establishes communications with the PCF/PCRF identified in the bearer data. The IMS core confirms a communication connection between the IMS core and the PCF/PCRF, whereby the dedicated bearer process continues.

In further examples, the gateway is configured to read an incoming Session Initiation Protocol (SIP) INVITE message from a user equipment (UE), using an INVITE Message analyzer, to establish a voice communication (e.g., a Voice over New Radio (VoNR) voice call or a VoNR emergency call). The gateway has either already received information from a source such as an NRF as to which one of the PCFs/PCRFs or may also query the NRF as to which one of the PCFs/PCRFs to use. The IP address and the PCF/PCRF that the UE will use (bearer data) is passed onto the IMS core. The IMS core receives the bearer data and, if not done so already, establishes communications with the PCF/PCRF identified in the bearer data. The IMS core confirms a communication connection between the IMS core and the PCF/PCRF, whereby the dedicated bearer process continues.

Generally, a server of the 5G telecommunication network can receive a call setup request message from a UE, and setup a control plane followed by setting up a user plane. The server can represent firmware, hardware and/or software that receives an initial call setup request (e.g., a Session Initiation Protocol (SIP) INVITE message) to establish a voice communication (e.g., a Voice over New Radio (VoNR) voice call or a VoNR emergency call) and generates a message (e.g., a user plane message) for sending to the UE to establish a communication session usable to exchange data with another UE. The server can send the message to the UE after determining that the UE lacks the software, hardware, and/or firmware to establish a call using the dedicated bearer. In some examples, the server can represent a Proxy Call Session Control Function (PCSCF) of an IP Multimedia Subsystem (IMS) core configured to manage control plane messages and/or user plane messages associated with a call request from a UE. For example, the server can determine whether a radio channel, a radio technology, and/or a chipset of the UE is sufficient for establishing the dedicated bearer, and if not, determine a protocol for using in the default bearer to connect the UE with another UE.

In some examples, the server can generate one or more message(s) for sending to a base station of the 5G network, a base station of the 4G network, an Access and Mobility Management Function (AMF), a Mobile Management Entity (MME), a gateway, to name a few. The one or more messages can ensure that the base station of the 5G network, the base station of the 4G network, the AMF, and/or the MME exchange data efficiently. Further description of communication setup techniques by the server can be found throughout this disclosure including in the figures below.

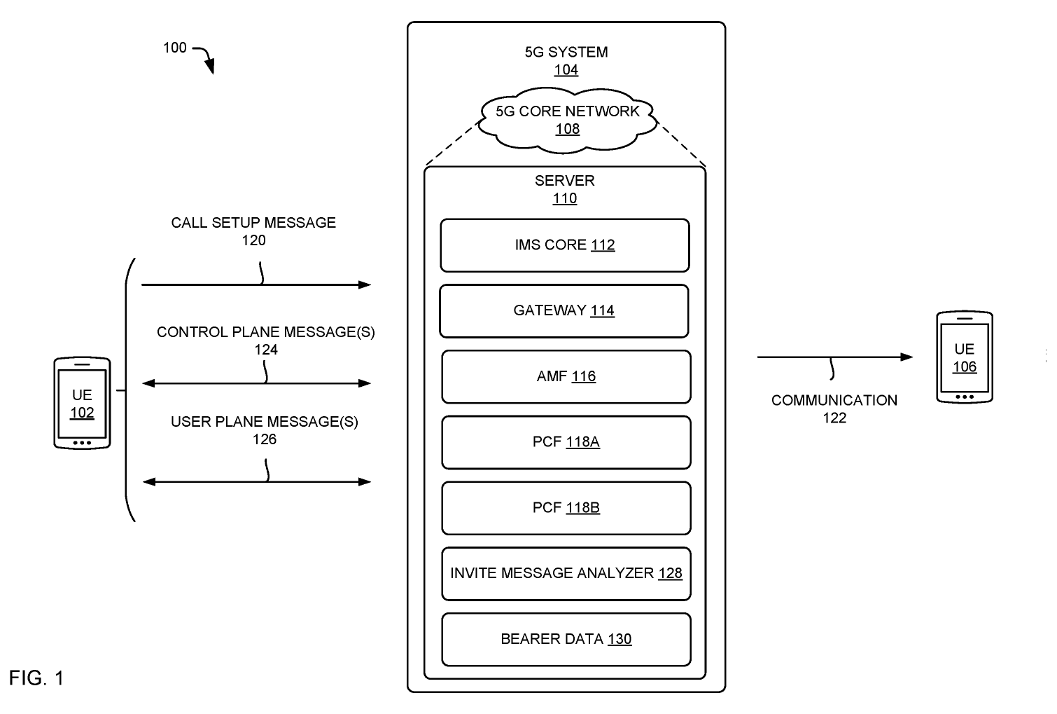

FIG. 1 depicts an example network environment 100 for directing IMS core communications, in accordance with some examples of the present disclosure. A UE 102 can connect to a 5G system 104 to exchange a voice communication (e.g., a VoNR communication) with one or more additional UEs (e.g., UE 106). In some examples, the UE 102 can connect to a 4G system, or other telecommunications system. The presently disclosed subject matter is not limited to the use of a 5G telecommunications system. The examples provided in FIG. 1 and any of the remaining figures in which a particular telecommunications system is described is merely for purposes of illustration one or more aspects of the presently disclosed subject matter and is not an intent to limit the scope of the presently disclosed subject matter to that particular type of telecommunications system.

Returning to FIG. 1, the UE 102 and the UE 106 represent any device that can wirelessly connect to the telecommunication network, and in some examples may include a mobile phone such as a smart phone or other cellular phone, a personal digital assistant (PDA), a personal computer (PC) such as a laptop, desktop, or workstation, a media player, a tablet, a gaming device, a smart watch, a hotspot, a Machine to Machine device (M2M), a vehicle, an unmanned aerial vehicle (UAV), an Internet of Things (IoT) device, or any other type of computing or communication device.

As depicted in FIG. 1, the 5G system 104 comprises a 5G core network 108 and a server 110 to establish a communication session between the UE 102 and the UE 106 using a default bearer that implements a predetermined protocol (e.g., RTP, RTCP, etc.). Generally, the server 110, which may be a single server or multiple servers, can implement various functions or components, such as an IP Multimedia Subsystem (IMS) core 112, a gateway 114, a PCF 118A, and a PCF 118B. In some examples, the gateway 114 can represent an SMF and/or a UPF in examples when the telecommunication network is a 5G core network. In further examples, the gateway 114 can represent a packet data network gateway (PDN GW) in a 4G and/or a 5G network.

In some examples, although illustrated as the PCF 118A and the PCF 118B, it should be understood that aspects of the presently disclosed subject matter may also be used for a policy and charging rules function (PCRF) that may be used in a 4G (4G LTE) telecommunications network. It should be further understood that the components and/or functions illustrated in FIG. 1 are merely for purposes of illustrating an aspect of the presently disclosed subject matter and does not represent all of the components that may be used in various types of telecommunications networks.

To implement the techniques described herein, in various examples the 5G system 104 and/or the server 110 can include one or more of: an a proxy call session control function (PCSCF), an interrogating call session control function (ICSCF), a serving call session control function (SCSCF), a serving gateway (SGW), a packet data network gateway (PGW), a policy and charging rules function (PCRF), and an internet protocol short message gateway (IPSM-GW), a short message service center (SMSC), and an evolved packet data gateway (ePDG), and a Home Subscriber Server (HSS), to name a few. In addition, the techniques described herein may be implemented using Real-Time Protocol (RTP) and/or Real-Time Control Protocol (RTCP), among others.

In various examples, the 5G system 104 can represent functionality to provide communications between the UE 102 and the UE 106 and can include one or more radio access networks (RANs), as well as one or more core networks linked to the RANs. For instance, a UE 102 can wirelessly connect to a base station or other access point of a RAN, and in turn be connected to the 5G core network 108. The RANs and/or core networks can be compatible with one or more radio access technologies, wireless access technologies, protocols, and/or standards. For example, wireless and radio access technologies can include fifth generation (5G) technology, Long Term Evolution (LTE)/LTE Advanced technology, other fourth generation (4G) technology, third generation (3G) technology, High-Speed Data Packet Access (HSDPA)/Evolved High-Speed Packet Access (HSPA+) technology, Universal Mobile Telecommunications System (UMTS) technology, Global System for Mobile Communications (GSM) technology, Wi-Fi technology, and/or any other previous or future generation of radio access technology. In this way, the 5G system 104 is compatible to operate with other radio technologies including those of other service providers. Accordingly, the call setup message 120 from the UE 102 may originate with another service provider (e.g., a third-party) and be processed by the IMS independent of the technolog(ies) or core network associated with the service provider.

In some examples, the 5G core network 108 can represent a service-based architecture that includes multiple types of network functions that process control plane data and/or user plane data to implement services for the UE 102. In some examples, the services comprise rich communication services (RCS), a VoNR service, a ViNR service, and the like which may include a text, a data file transfer, an image, a video, or a combination thereof. The network functions of the 5G core network 108 can include an Access and Mobility Management Function (AMF), a Session Management Function (SMF), a User Plane Function (UPF), a Policy Control Function (PCF), and/or other network functions implemented in software and/or hardware, to name a few.

To implement the call setup techniques described herein, the UE 102 can initiate a call setup procedure (e.g., an exchange of a plurality of messages that establish the communication channel) by sending the call setup message 120 to establish a voice call to the 5G system 104. The call setup procedure can include, for instance, establishing a control plane and a user plane that enables the UE 102 to exchange data (e.g., data packets for a voice or video call) with the UE 106. In various examples, the 5G system 104 can initiate, establish, maintain, format, augment, manage, or otherwise determine secure exchange of text, video, and/or photos including configuring the communication 122 to communicate with the UE 106.

In some examples, the server 110 and/or the UE 102 can generate one more control plane message(s) 124 to establish a control plane between the server 110 and the UE 102 using a default bearer (e.g., a Create Session Response, a Session Initiation Protocol (SIP) message, or the like). Based at least in part on exchanging the control plane message(s) 124, the control plane can be successfully established and the UE 102 and the server 110 can generate one or more user plane message(s) 126 (e.g., a Create Bearer Request, a Create Bearer Response, a Dedicated Bearer Context Setup Request, a Dedicated Bearer Context Setup Response, a diameter message, and so on) to establish a user plane for the communication channel using the dedicated bearer.

As part of process for establishing a dedicated bearer between the UE 102 and the server 110, the server 110 can configure the gateway 114 to use an invite message analyzer 128. The invite message analyzer 128 is a process used by a component of the server 110, such as the gateway 114, that analyzes an incoming SIP INVITE message (e.g., the call setup message 120). The analysis is done for the purpose of informing the IMS core 112 of which PCF, such as the PCF 118A or the PCF 118B, to which the dedicated bearer will be established. The purpose of doing so is to ensure that the IMS core 112 either has established or will establish communications with the particular PCF to which the dedicated bearer will be established. As noted above, if the IMS core 112 receives a message from the gateway 114 to establish a dedicated bearer but is in communication with an incorrect PCF, the dedicated bearer process may fail. For example, if the IMS core 112 is in communication with the PCF 118B, but the PCF 118A is actually the PCF to be used for the call connection, the gateway 114 may issue a dedicated bearer call setup error because the gateway 114 is establishing the dedicated bearer with the PCF 118A but the IMS core 112 is communicating with the wrong PCF, i.e., the PCF 118B.

Once the call setup message 120 is analyzed using the invite message analyzer 128, bearer data 130 is generated. The bearer data 130 can include information such as, but not limited to, the IP address assigned to the UE 102 attempting to establish the call, as well as the identity of the PCF to be used to establish the call. The IMS core 112 receives this information and either confirms that that the IMS core 112 has already established communication with the PCF identified in the bearer data 130 or establishes communication with the PCF. Once the communication with PCF is either confirmed or is established, the IMS core 112 notifies the gateway 114 that the IMS core is ready to be used for the establishment of the dedicated bearer.

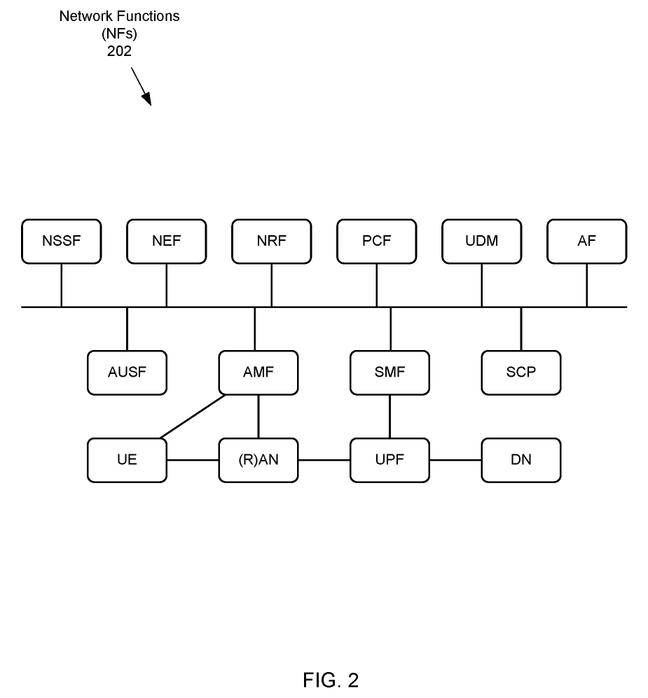

FIG. 2 depicts an example system architecture for a fifth generation (5G) telecommunication network that may be used to implement the invite message analyzer 128 of FIG. 1, in accordance with some examples of the present disclosure. In some examples, the telecommunication network can comprise the 5G core network 108 in FIG. 1 that includes a service-based system architecture in which different types of network functions (NFs) 202 operate alone and/or together to implement services. Standards for 5G communications define many types of NFs 202 that can be present in 5G telecommunication networks (e.g., the 5G core network 108), including but not limited to an Authentication Server Function (AUSF), Access and Mobility Management Function (AMF), Data Network (DN), Unstructured Data Storage Function (UDSF), Network Exposure Function (NEF), Network Repository Function (NRF), Network Slice Selection Function (NSSF), Policy Control Function (PCF), Session Management Function (SMF), Unified Data Management (UDM), Unified Data Repository (UDR), User Plane Function (UPF), Application Function (AF), User Equipment (UE), (Radio) Access Network ((R)AN), 5G-Equipment Identity Register (5G-EIR), Network Data Analytics Function (NWDAF), Charging Function (CHF), Service Communication Proxy (SCP), Security Edge Protection Proxy (SEPP), Non-3GPP InterWorking Function (N3IWF), Trusted Non-3GPP Gateway Function (TNGF), and Wireline Access Gateway Function (W-AGF), many of which are shown in the example system architecture of FIG. 2.

One or more of the NFs 202 of the 5G core network 108 can be implemented as network applications that execute within containers (not shown). The NFs 202 can execute as hardware elements, software elements, and/or combinations of the two within telecommunication network(s), and accordingly many types of the NFs 202 can be implemented as software and/or as virtualized functions that execute on cloud servers or other computing devices. Network applications that can execute within containers can also include any other type of network function, application, entity, module, element, or node.

The 5G core network 108 can, in some examples, determine a connection between an IMS that manages a communication session for the UE 102, including sessions for short messaging, voice calls, video calls, and/or other types of communications. For example, the UE 102 and the IMS of the 5G system 104 can exchange Session Initiation Protocol (SIP) messages to set up and manage individual communication sessions. In some examples, the IMS of the 5G system 104 can generate a communication channel for a voice communication between the UE 102 and the UE 106.

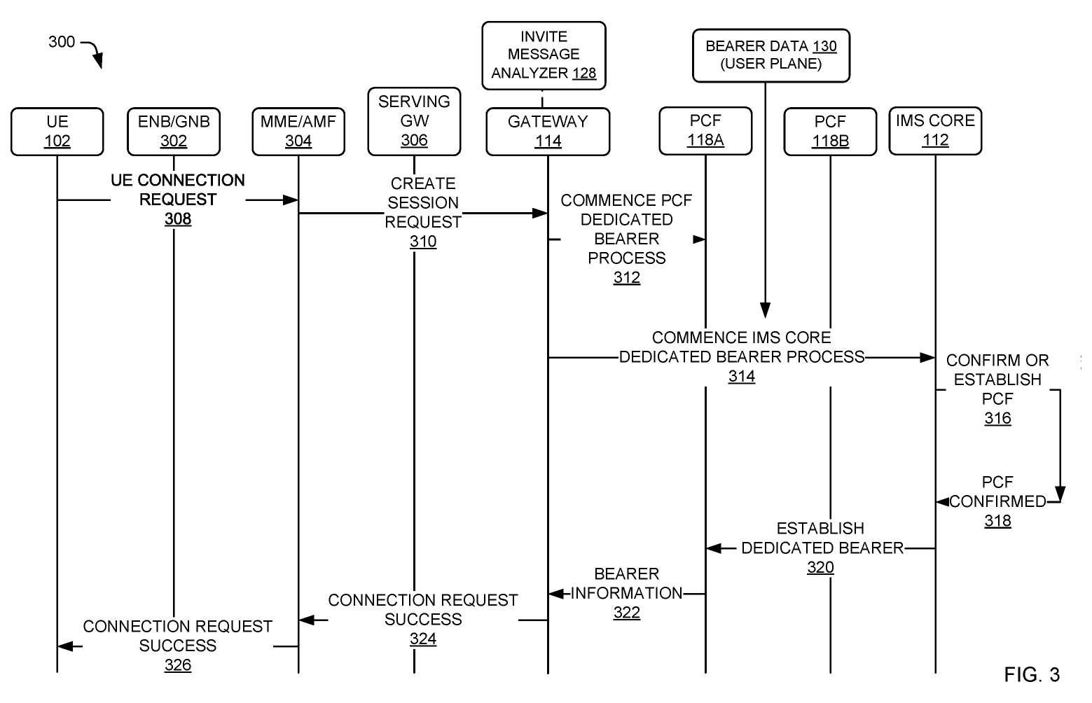

FIG. 3 depicts a message flow 300 during an example dedicated bearer setup implementing the invite message analyzer 128 of FIG. 1, in accordance with some examples of the present disclosure. It should be noted that not all messages used to establish a call connection are illustrated in FIG. 3. In some examples, the messaging flow 300 as shown in FIG. 3 can represent activity to establish a communication session between the UE 102 and the UE 106 by exchanging messages between the UE 102, an eNB/gNB 302, an MME/AMF 304, a serving gateway 306, the gateway 114, the PCF 118A and/or the PCF 118B, and the IMS core 112. As shown in FIG. 3, the 5G core network includes the PCF 118A and the PCF 118B. As further shown in FIG. 3, the gateway 114 can include the functionality associated with the invite message analyzer 128.

The messaging flow 300 can include the UE 102 initiating a voice call by sending UE connection request 308 to the MME/AMF 304 via eNB/gNB 302. In examples where a 5G core network is used, the UE 102 can send the request to the gNB 302 and the AMF 304. In examples where a 4G core network is used, the UE 102 can send the request to the eNB 302 and the MME 304. Thus, depending on the telecommunications network, only one of the MME or the AMF, or one of the eNB or the gNB may be used in implementations. The MME/AMF 304 can generate and send a Create Session Request 310 to the gateway 306. The gateway 306 can represent one of : a System Architecture Evolution Gateway (SAEGW), a Packet Data Network Gateway (PGW), a Session Management Function (SMF), a User Plane Function (UPF), a Serving Gateway (SGW), or the like depending on which telecommunications network (5G, 4G, 3G, etc.) is used by the UE 102.

In some examples, the message flow 300 can continue by the gateway 114 commencing the dedicated bearer process 312 with a particular PCF, in this example the PCF 118A, and commencing the IMS core dedicated bearer process 314. In the example illustrated in FIG. 3, the gateway 114 is to use the PCF 118A rather than the PCF 118B. This may be due to various reasons. For example, the UE 102 configuration may require the use of the PCF 118A. In another example, the PCF 118B may be offline. In a still further example, the gateway 114 may have received information from an NRF (such as from FIG. 2) that the gateway 114 is to use the PCF 118A for various reasons, such as load balancing. As part of the process of the IMS core dedicated bearer process 314, the gateway will generate the bearer data 130 and transmit the bearer data 130 to instruct the IMS core 112 to establish or use the PCF 118A rather than the PCF 118B for this instance of establishing a call. It should be understood that the bearer data 130 may change from call setup to call setup, even with the same UE 102, as the gateway 114 may receive updated instructions per call setup to instruct the IMS core to use different PCFs.

The message flow 300 can continue by the IMS core 112 receiving the bearer data 130 and confirming or establishing communications 316 with the PCF 118A identified in the bearer data 130. Once the IMS core 112 either confirms or establishes communications with 318 the PCF 118A identified in the bearer data 130, the message flow 300 continues by the IMS core 112 establishing a dedicated bearer 320 using the PCF 118A. The call flow 300 continues by the PCF 118A notifying 322 the gateway 114 of the bearer information, whereby the gateway completes the process of establishing a call connection 324 by sending a connection request success message 324 to the MME/AMF 304 which then sends a successful connection response message 326 to the UE 102 (via the eNB/gNB 302). By exchanging the messages noted above, the UE 102 can complete SIP registration or otherwise establish a control plane with the PCF 118A.

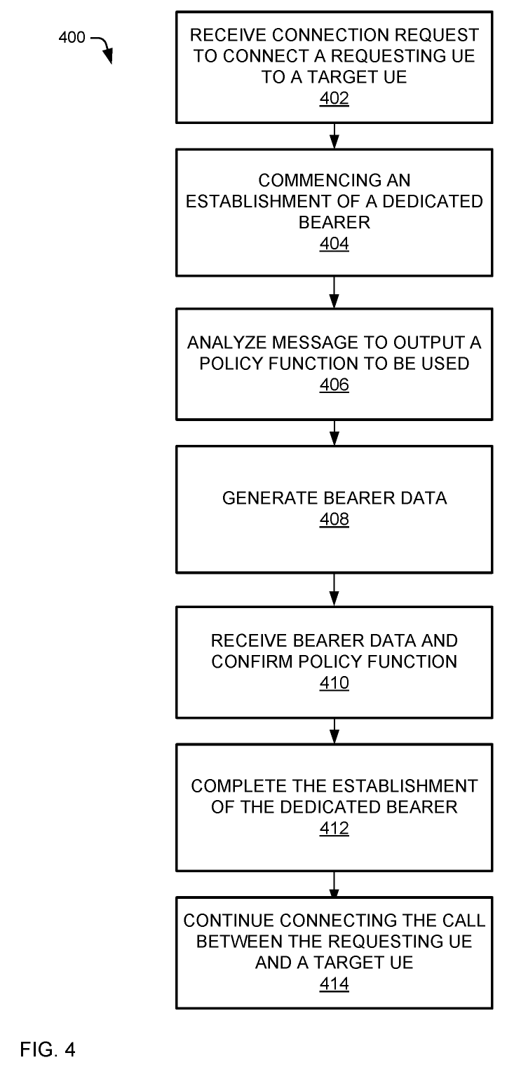

FIG. 4 is an illustrative process 400 for establishing a dedicated bearer for a communication session, in accordance with some examples of the present disclosure. The process 400 and other processes described herein are illustrated as example flow graphs, each operation of which may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Referring now to FIG. 4, the process 400 commences at operation 402, where a server 110 of telecommunications network receives a message from the UE 102, the message requesting the establishment of a communication session with the UE 106. The UE 102 can initiate a call setup procedure (e.g., an exchange of a plurality of messages that establish the communication channel) by sending the call setup message 120 to establish a voice call to the 5G system 104. The call setup procedure can include, for instance, establishing a control plane and a user plane that enables the UE 102 to exchange data (e.g., data packets for a voice or video call) with the UE 106. In various examples, the 5G system 104 can initiate, establish, maintain, format, augment, manage, or otherwise determine secure exchange of text, video, and/or photos including configuring the communication 122 to communicate with the UE 106. At operation 404, a gateway receives the message from the UE 102.

At operation 404, the server 110 commences the establishment of a dedicated bearer for the communication session. As noted above, if the IMS core 112 receives a message from the gateway 114 to establish a dedicated bearer but the IMS core 112 is in communication with an incorrect PCF, the dedicated bearer process may fail. For example, if the IMS core 112 is in communication with the PCF 118B, but the PCF 118A is actually the PCF to be used for the call connection, the gateway 114 may issue a dedicated bearer call setup error because the gateway 114 is establishing the dedicated bearer with the PCF 118A but the IMS core 112 is communicating with the wrong PCF, i.e., the PCF 118B. Thus, operation 404 and the following operations of the process 400 are used by the server 110 to reduce the probability of a failure of a dedicated bearer process by using a specific policy function.

At operation 406, the server 110 analyzes the message from the UE 102 to output a policy function to be used by the IMS core 112 for the communication session. The policy function to be used is correct. If the IMS core 112 receives a message from the gateway 114 to establish a dedicated bearer but is in communication with an incorrect PCF, the dedicated bearer process may fail. For example, if the IMS core 112 is in communication with the PCF 118B, but the PCF 118A is actually the PCF to be used for the call connection, the gateway 114 may issue a dedicated bearer call setup error because the gateway 114 is establishing the dedicated bearer with the PCF 118A but the IMS core 112 is communicating with the wrong PCF, i.e., the PCF 118B.

At operation 408, bearer data is generated including the policy function to be used by the IMS core 112. A purpose of doing so is to ensure that the IMS core 112 either has established or will establish communications with the particular PCF to which the dedicated bearer will be established. The bearer data 130 can include information such as, but not limited to, the IP address assigned to the UE 102 attempting to establish the call, as well as the identity of the PCF to be used to establish the call.

At operation 410, the IMS core 112 receives the bearer data from operation 408 and either confirms that that the IMS core 112 has already established communication with the PCF identified in the bearer data 130 or establishes communication with the PCF. Once the communication with PCF is either confirmed or is established, the IMS core 112 notifies the gateway 114 that the IMS core is ready to be used for the establishment of the dedicated bearer.

At operation 412, the establishment of the dedicated bearer is completed and at operation 414, the network continues the process of connecting the UE 102 with the UE 106. The process 400 thereafter ends.

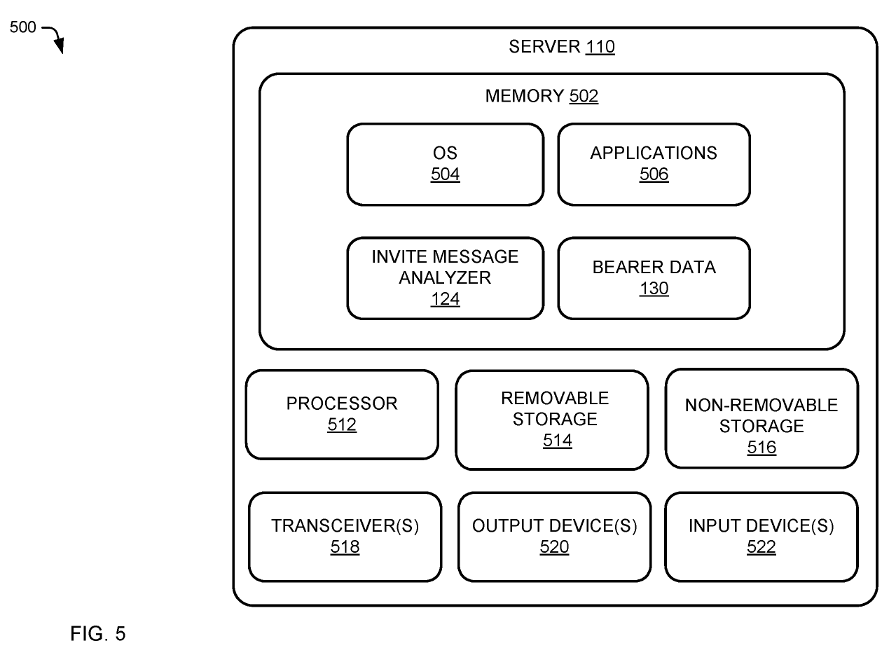

FIG. 5 depicts a component level view of the server 110 for use with the systems and methods described herein, in accordance with some examples of the present disclosure. The server 110 could be any device capable of communicating using the 5G core network 108. The server 110 can comprise several components to execute the above-mentioned functions. As discussed below, the server 110 can comprise memory 502 including an operating system (OS) 504 and one or more standard applications 506. The standard applications 506 can comprise a video call application, an audio call application, and a messaging application to enable users to engage in audio calls, video calls, and messaging, among other things.

The server 110 can also comprise one or more processors 512 and one or more of removable storage 514, non-removable storage 516, transceiver(s) 518, output device(s) 520, and input device(s) 522. In various implementations, the memory 502 can be volatile (such as random access memory (RAM)), non-volatile (such as read only memory (ROM), flash memory, etc.), or some combination of the two. The memory 502 can include all, or part, of the message analyzer 128. In some examples, rather than being stored in the memory 502, some, or all, of the invite message analyzer 128 can be stored on a remote server or a cloud of servers accessible by the server 110.

The memory 502 can also include the OS 504. The OS 504 varies depending on the manufacturer of the server 110. The OS 504 contains the modules and software that support basic functions of the server 110, such as scheduling tasks, executing applications, and controlling peripherals. In some examples, the OS 504 can enable the message analyzer 128 and provide other functions, as described above, via the transceiver(s) 518. The OS 504 can also enable the server 110 to send and retrieve other data and perform other functions. The memory 502 can also store other data such as, but not limited to, the bearer data 130.

The server 110 can also comprise one or more processors 512. In some implementations, the processor(s) 512 can be one or more central processing units (CPUs), graphics processing units (GPUs), both CPU and GPU, or any other processing unit. The server 110 may also include additional data storage devices (removable and/or non-removable) such as, for example, magnetic disks, optical disks, or tape. Such additional storage is illustrated in FIG. 5 by removable storage 514 and non-removable storage 516.

Non-transitory computer-readable media may include volatile and nonvolatile, removable and non-removable tangible, physical media implemented in technology for storage of information, such as computer readable instructions, data structures, program modules, or other data. The memory 502, removable storage 514, and non-removable storage 516 are all examples of non-transitory computer-readable media. Non-transitory computer-readable media include, but are not limited to, RAM, ROM, electronically erasable programmable ROM (EEPROM), flash memory or other memory technology, compact disc ROM (CD-ROM), digital versatile discs (DVD) or other optical storage, magnetic cassettes, magnetic tape, magnetic disk storage or other magnetic storage devices, or any other tangible, physical medium which can be used to store the desired information and which can be accessed by the server 110. Any such non-transitory computer-readable media may be part of the server 110 or may be a separate database, databank, remote server, or cloud-based server.

In some implementations, the transceiver(s) 518 include any transceivers known in the art. In some examples, the transceiver(s) 518 can include wireless modem(s) to facilitate wireless connectivity with other components (e.g., between the server 110 and a wireless modem that is a gateway to the Internet), the Internet, and/or an intranet. Specifically, the transceiver(s) 518 can include one or more transceivers that can enable the server 110 to send and receive data, video calls, audio calls, and messages and to perform other functions, such as communications with the NRF of FIG. 2. Thus, the transceiver(s) 518 can include multiple single-channel transceivers or a multi-frequency, multi-channel transceiver to enable the server 110 to send and receive video calls, audio calls, messaging, etc. The transceiver(s) 518 can enable the server 110 to connect to multiple networks including, but not limited to 2G, 3G, 4G, 5G, and Wi-Fi networks. The transceiver(s) can also include one or more transceivers to enable the server 110 to connect to future (e.g., 6G) networks, Internet-of-Things (IoT), machine-to machine (M2M), and other current and future networks.

The transceiver(s) 518 may also include one or more radio transceivers that perform the function of transmitting and receiving radio frequency communications via an antenna (e.g., Wi-Fi or Bluetooth^{®}). In other examples, the transceiver(s) 518 may include wired communication components, such as a wired modem or Ethernet port, for communicating via one or more wired networks. The transceiver(s) 518 can enable the server 110 to make audio and video calls, download files, access web applications, and provide other communications associated with the systems and methods, described above.

In some implementations, the output device(s) 520 include any output devices known in the art, such as a display (e.g., a liquid crystal or thin-film transistor (TFT) display), a touchscreen, speakers, a vibrating mechanism, or a tactile feedback mechanism. Thus, the output device(s) can include a screen or display. The output device(s) 520 can also include speakers, or similar devices, to play sounds or ringtones when an audio call or video call is received. Output device(s) 520 can also include ports for one or more peripheral devices, such as headphones, peripheral speakers, or a peripheral display.

In various implementations, input device(s) 522 include any input devices known in the art. For example, the input device(s) 522 may include a camera, a microphone, or a keyboard/keypad. The input device(s) 522 can include a touch-sensitive display or a keyboard to enable users to enter data and make requests and receive responses via web applications (e.g., in a web browser), make audio and video calls, and use the standard applications 506, among other things. In some examples, the input device(s) 522 may be a communication cable connected between the server 110 and a device such that communications between the server 110 and the device is a wired connection. The touch-sensitive display or keyboard/keypad may be a standard push button alphanumeric multi-key keyboard (such as a conventional QWERTY keyboard), virtual controls on a touchscreen, or one or more other types of keys or buttons, and may also include a joystick, wheel, and/or designated navigation buttons, or the like. A touch sensitive display can act as both an input device 522 and an output device 520.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

Conclusion

Although the subject matter has been described in language specific to structural features and/or methodological acts, it is to be understood that the subject matter is not necessarily limited to the specific features or acts described above. Rather, the specific features and acts described above are disclosed as example embodiments.

While one or more examples of the techniques described herein have been described, various alterations, additions, permutations and equivalents thereof are included within the scope of the techniques described herein, some examples of which are provided in the following clauses:

Clause 1. A method comprising: receiving, by a server of telecommunications network, a message from a first user equipment (UE) requesting a communication session with a second UE; receiving, by a gateway of the telecommunications network, the message from the first UE; commencing, by the gateway, an establishment of a dedicated bearer for the communication session; analyzing, by an invite message analyzer, the message from the first UE to output a policy function to be used by an IP multimedia subsystem core (IMS core) for the communication session; generating, by the gateway, bearer data including the policy function to be used by the IMS core; receiving, by the IMS core, the bearer data and confirming communications with the policy function to be used or establishing communications with the policy function to be used by the IMS core; and completing the establishment of the dedicated bearer for the communication session.

Clause 2. The method of clause 1, wherein: the telecommunications network is a 4G network and the policy function is a policy and charging rules function (PCRF); or the telecommunications network is a 5G network and the policy function is a policy control function (PCF).

Clause 3. The method of clause 1, wherein: the telecommunications network is a 4G network and the gateway is a packet data network gateway (PDN GW); or the telecommunications network is a 5G network and the gateway is a session management function (SMF) and/or a user plane function (UPF).

Clause 4. The method of clause 1, wherein the policy function is based on an Internet Protocol address or identification of the first UE.

Clause 5. The method of clause 1, wherein analyzing, by the invite message analyzer, the message from the first UE to output the policy function comprises: querying a new radio function (NRF) to provide the policy function to be used for the communication session; and receiving from the NRF the policy function to be used for the communication session.

Clause 6. The method of clause 5, wherein the policy function to be used is based on a load balancing process to load balance the policy function and a plurality of second policy functions.

Clause 7. The method of clause 5, wherein the policy function to be used is based on a process attempting to prevent a use of inoperable or unavailable plurality of second policy functions.

Clause 8. The method of clause 5, wherein the policy function to be used is based on a process to commence a use of a newly operable policy function.

Clause 9. A system comprising: one or more processors; and memory storing computer-executable instructions that, when executed by the one or more processors, cause the system to perform operations comprising: receiving, by a server of telecommunications network, a message from a first user equipment (UE) requesting a communication session with a second UE; receiving, by a gateway of the telecommunications network, the message from the first UE; commencing, by the gateway, an establishment of a dedicated bearer for the communication session; analyzing, by an invite message analyzer, the message from the first UE to output a policy function to be used by an IP multimedia subsystem core (IMS core) for the communication session; generating, by the gateway, bearer data including the policy function to be used by the IMS core; receiving, by the IMS core, the bearer data and confirming communications with the policy function to be used or establishing communications with the policy function to be used by the IMS core; and completing the establishment of the dedicated bearer for the communication session.

Clause 10. The system of clause 9, wherein: the telecommunications network is a 4G network and the policy function is a policy and charging rules function (PCRF); or the telecommunications network is a 5G network and the policy function is a policy control function (PCF).

Clause 11. The system of clause 9, wherein: the telecommunications network is a 4G network and the gateway is a packet data network gateway (PDN GW); or the telecommunications network is a 5G network and the gateway is a session management function (SMF) and/or a user plane function (UPF) .

Clause 12. The system of clause 9, wherein the policy function is based on an Internet Protocol address or identification of the first UE.

Clause 13. The system of clause 9, wherein analyzing, by the invite message analyzer, the message from the first UE to output the policy function comprises the operations of: querying a new radio function (NRF) to provide the policy function to be used for the communication session; and receiving from the NRF the policy function to be used for the communication session.

Clause 14. The system of clause 13, wherein the policy function to be used is based on a load balancing process to load balance the policy function and a plurality of second policy functions.

Clause 15. The system of clause 13, wherein the policy function to be used is based on a process attempting to prevent a use of inoperable or unavailable plurality of second policy functions.

Clause 16. The system of clause 13, wherein the policy function to be used is based on a process to commence a use of a newly operable policy function.

Clause 17. One or more non-transitory computer-readable media storing instructions executable by one or more processors, wherein the instructions, when executed, cause the one or more processors to perform operations comprising: receiving, by a server of telecommunications network, a message from a first user equipment (UE) requesting a communication session with a second UE; receiving, by a gateway of the telecommunications network, the message from the first UE; commencing, by the gateway, an establishment of a dedicated bearer for the communication session; analyzing, by an invite message analyzer, the message from the first UE to output a policy function to be used by an IP multimedia subsystem core (IMS core) for the communication session; generating, by the gateway, bearer data including the policy function to be used by the IMS core; receiving, by the IMS core, the bearer data and confirming communications with the policy function to be used or establishing communications with the policy function to be used by the IMS core; and completing the establishment of the dedicated bearer for the communication session.

Clause 18. The one or more non-transitory computer-readable media of clause 17, wherein: the telecommunications network is a 4G network and the policy function is a policy and charging rules function (PCRF) and the gateway is a packet data network gateway (PDN GW); or the telecommunications network is a 5G network and the policy function is a policy control function (PCF) and the gateway is a session management function (SMF) and/or a user plane function (UPF).

Clause 19. The one or more non-transitory computer-readable media of clause 17, wherein determining that the communication session cannot be established using the dedicated bearer comprises: wherein analyzing, by the invite message analyzer, the message from the first UE to output the policy function comprises: querying a new radio function (NRF) to provide the policy function to be used for the communication session; and receiving from the NRF the policy function to be used for the communication session.

Clause 20. The one or more non-transitory computer-readable media of clause 17, wherein the policy function to be used is based on at least one of: a load balancing process to load balance the policy function and a plurality of second policy functions; a process attempting to prevent a use of inoperable or unavailable plurality of second policy functions; or a process to commence a use of a newly operable policy function.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A method comprising:
receiving, by a server of telecommunications network, a message from a first user equipment (UE) requesting a communication session with a second UE;
receiving, by a gateway of the telecommunications network, the message from the first UE;
commencing, by the gateway, an establishment of a dedicated bearer for the communication session;
analyzing, by an invite message analyzer, the message from the first UE to output a policy function to be used by an IP multimedia subsystem core (IMS core) for the communication session;
generating, by the gateway, bearer data including the policy function to be used by the IMS core;
receiving, by the IMS core, the bearer data and confirming communications with the policy function to be used or establishing communications with the policy function to be used by the IMS core; and
completing the establishment of the dedicated bearer for the communication session.

2. The method of claim 1, wherein:
the telecommunications network is a 4G network and the policy function is a policy and charging rules function (PCRF); or
the telecommunications network is a 5G network and the policy function is a policy control function (PCF).

3. The method of claim 1, wherein:
the telecommunications network is a 4G network and the gateway is a packet data network gateway (PDN GW); or
the telecommunications network is a 5G network and the gateway is a session management function (SMF) and/or a user plane function (UPF).

4. The method of claim 1, wherein the policy function is based on an Internet Protocol address or identification of the first UE.

5. The method of claim 1, wherein analyzing, by the invite message analyzer, the message from the first UE to output the policy function comprises:
querying a new radio function (NRF) to provide the policy function to be used for the communication session; and
receiving from the NRF the policy function to be used for the communication session.

6. The method of claim 5, wherein the policy function to be used is based on a load balancing process to load balance the policy function and a plurality of second policy functions.

7. The method of claim 5, wherein the policy function to be used is based on a process attempting to prevent a use of inoperable or unavailable plurality of second policy functions.

8. The method of claim 5, wherein the policy function to be used is based on a process to commence a use of a newly operable policy function.

9. A system comprising:
one or more processors; and
memory storing computer-executable instructions that, when executed by the one or more processors, cause the system to perform operations comprising:
receiving, by a server of telecommunications network, a message from a first user equipment (UE) requesting a communication session with a second UE;
receiving, by a gateway of the telecommunications network, the message from the first UE;
commencing, by the gateway, an establishment of a dedicated bearer for the communication session;
analyzing, by an invite message analyzer, the message from the first UE to output a policy function to be used by an IP multimedia subsystem core (IMS core) for the communication session;
generating, by the gateway, bearer data including the policy function to be used by the IMS core;
receiving, by the IMS core, the bearer data and confirming communications with the policy function to be used or establishing communications with the policy function to be used by the IMS core; and
completing the establishment of the dedicated bearer for the communication session.

10. The system of claim 9, wherein:
the telecommunications network is a 4G network and the policy function is a policy and charging rules function (PCRF); or
the telecommunications network is a 5G network and the policy function is a policy control function (PCF).

11. The system of claim 9, wherein:
the telecommunications network is a 4G network and the gateway is a packet data network gateway (PDN GW); or
the telecommunications network is a 5G network and the gateway is a session management function (SMF) and/or a user plane function (UPF) .

12. The system of claim 9, wherein the policy function is based on an Internet Protocol address or identification of the first UE.

13. The system of claim 9, wherein analyzing, by the invite message analyzer, the message from the first UE to output the policy function comprises the operations of:
querying a new radio function (NRF) to provide the policy function to be used for the communication session; and
receiving from the NRF the policy function to be used for the communication session.

14. The system of claim 13, wherein the policy function to be used is based on a load balancing process to load balance the policy function and a plurality of second policy functions.

15. The system of claim 13, wherein the policy function to be used is based on a process attempting to prevent a use of inoperable or unavailable plurality of second policy functions.

16. The system of claim 13, wherein the policy function to be used is based on a process to commence a use of a newly operable policy function.

17. One or more non-transitory computer-readable media storing instructions executable by one or more processors, wherein the instructions, when executed, cause the one or more processors to perform operations comprising:
receiving, by a server of telecommunications network, a message from a first user equipment (UE) requesting a communication session with a second UE;
receiving, by a gateway of the telecommunications network, the message from the first UE;
commencing, by the gateway, an establishment of a dedicated bearer for the communication session;
analyzing, by an invite message analyzer, the message from the first UE to output a policy function to be used by an IP multimedia subsystem core (IMS core) for the communication session;
generating, by the gateway, bearer data including the policy function to be used by the IMS core;
receiving, by the IMS core, the bearer data and confirming communications with the policy function to be used or establishing communications with the policy function to be used by the IMS core; and
completing the establishment of the dedicated bearer for the communication session.

18. The one or more non-transitory computer-readable media of claim 17, wherein:
the telecommunications network is a 4G network and the policy function is a policy and charging rules function (PCRF) and the gateway is a packet data network gateway (PDN GW); or
the telecommunications network is a 5G network and the policy function is a policy control function (PCF) and the gateway is a session management function (SMF) and/or a user plane function (UPF).

19. The one or more non-transitory computer-readable media of claim 17, wherein determining that the communication session cannot be established using the dedicated bearer comprises:
wherein analyzing, by the invite message analyzer, the message from the first UE to output the policy function comprises:
querying a new radio function (NRF) to provide the policy function to be used for the communication session; and
receiving from the NRF the policy function to be used for the communication session.

20. The one or more non-transitory computer-readable media of claim 17, wherein the policy function to be used is based on at least one of:
a load balancing process to load balance the policy function and a plurality of second policy functions;
a process attempting to prevent a use of inoperable or unavailable plurality of second policy functions; or
a process to commence a use of a newly operable policy function.
